(19) United States
(12) Patent Application Publication
(10) Pub. No.: US 2021/0181390 A1
(43) Pub. Date: Jun. 17, 2021

(54) DIFFRACTIVE OPTICAL STRUCTURE AND A STRUCTURED LIGHT PROJECTION DEVICE HAVING THE SAME

(71) Applicant: TRIPLE WIN TECHNOLOGY(SHENZHEN) CO.LTD., Shenzhen (CN)

(72) Inventors: JI-PENG LIU, Shenzhen (CN); CHUN-HUNG CHEN, Tu-Cheng (TW)

(21) Appl. No.: 16/733,998

(22) Filed: Jan. 3, 2020

(30) Foreign Application Priority Data
Dec. 12, 2019 (CN) 201922245898.X

(51) Int. Cl. G02B 5/18; G02B 27/42

(52) U.S. Cl. CPC G02B 5/18; G02B 27/4233

(57) ABSTRACT

A diffractive optical structure achieving high resolution to facilitate face recognition includes a first diffractive element and a second diffractive element. The first diffractive element includes first grating structures and the second diffractive element comprises second grating structures. The second grating structures each face and are spaced apart from the first grating structures, an adhesive with certain optical properties is infilled between the first grating structure and the second grating structure.

The subject matter herein generally relates to optical devices, in particular relates to a diffractive optical structure and a structured light projection device having the same.

### BACKGROUND

Depth camera realizes 3D scanning, scene modeling, and gesture recognition by calculating different depths. For example, the combination of depth camera, TV, computer, and so on can realize somatosensory game to achieve the effect of game and fitness. A core component of a depth camera is optical projection module. In order to acquire information as to depths, the depth camera includes light emission module which produces a specific type of structured light. The structured light projection module is generally composed of light source, collimation module, and diffractive optical module (DOE). However, when light is incident to the DOE, spots formed by the DOE are scattered, and this structured light used in face recognition results in a low resolution of structure pattern.

### BRIEF DESCRIPTION OF THE DRAWINGS

Implementations of the present technology are described, by way of embodiments, with reference to the attached figures.

FIG. 1 is a cross-section view of a diffractive optical structure in accordance with one exemplary embodiment.

FIG. 2 is a diagrammatic view of a structured light projection device in accordance with one exemplary embodiment.

FIG. 3 is a diagrammatic view of a light path of a diffractive optical structure in accordance with one exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain portions may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

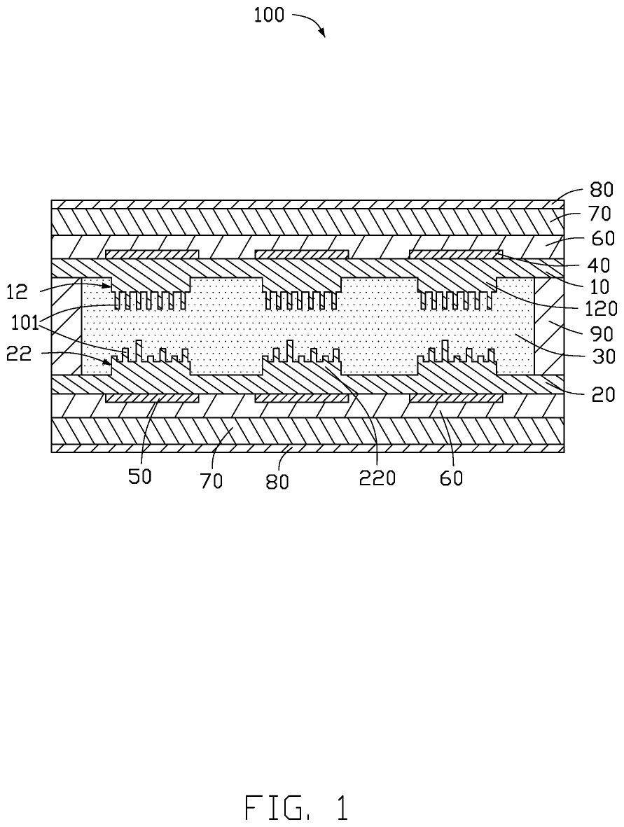

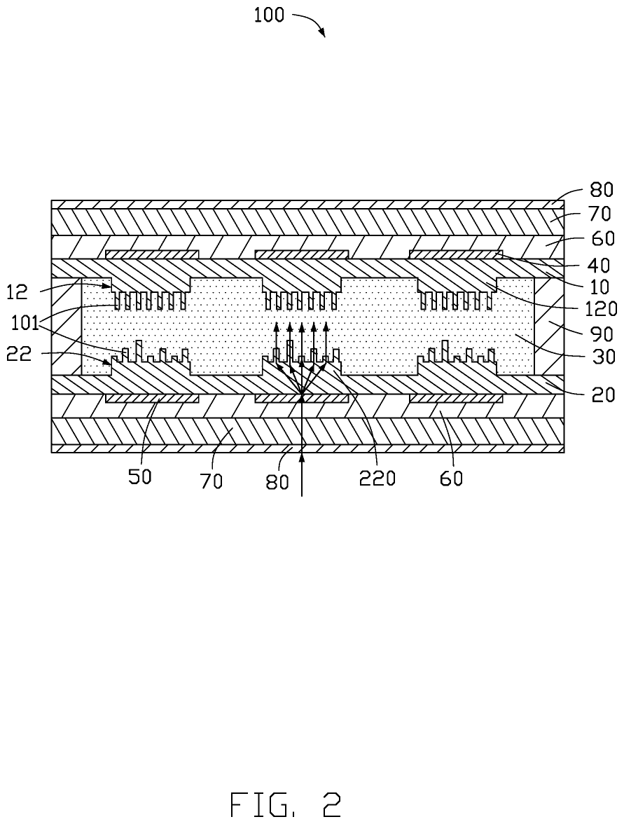

FIG. 1 illustrates a diffractive optical structure 100 according to a first embodiment. FIG. 2 is an optical path diagram of the diffractive optical structure provided in FIG. 1. The diffractive optical structure 100 receives and splits the light beam and projects a patterned light beam with uniform energy distribution and high contrast in a way of image superposition. By using the diffractive optical structure 100 for beam shaping, a uniform light or structured light field can be efficiently produced. The diffractive optical structure 100 includes a first diffractive element 10, a second diffractive element 20 facing and spaced apart from the first diffractive element 10, and an optical adhesive 30 filled between the first diffractive element 10 and the second diffractive element 20.

The optical adhesive 30 can be a fir glue, a methanol glue, an unsaturated polyvinylene, a styrene monomer glue, an epoxy resin optical adhesive, an organic silicon resin adhesive, and the like, the optical adhesive being higher in light transmittance and in refractive index. A refractive index of the optical adhesive 30 is substantially equal to a refractive index of the first diffractive element 10. The optical adhesive 30 increases efficiency of light transmission. In the present embodiment, a refractive index of the optical adhesive 30 is between 1.45 and 1.55.

When light is emitted from the first diffractive element 10, the light is refracted by the optical adhesive 30 and directed to the second diffractive element 20. The light is relatively concentrated to increase the amount of light passing through the second diffractive element 20. That is, the optical adhesive 30 adjusts an angle of light entering the second diffractive element 20, and prevents light from being incident on both sides of the second diffractive element 20. Emission rate of light from the second diffractive element 20 is thus improved.

The optical adhesive 30 also prevents the first diffractive element 10 and the second diffractive element being forcibly deformed, and can effectively prevent foreign matter such as dust from entering between the first diffractive element 10 and the second diffractive element 20, thereby reducing loss-rate of light.

In particular, the first diffractive element 10 includes a first grating structure 12, the second diffractive element 20 includes a second grating structure 22, the first grating structure 12 is arranged relative to the second grating structure 22, and the optical adhesive 30 is arranged between the first grating structure 12 and the second grating structure 22. The first diffractive element 10 and the second diffractive element 20 may be of a glass material or a polymer (plastic) material, generally fabricated by etching a transparent substrate surface of a glass or plastic material to a certain depth and with regular or irregular grating microstructures, by means of electron beam direct-writing or other means.

In particular, the first grating structure 12 comprises at least one first microstructural portion 120, the second grating structure 22 comprises at least one second microstructural portion 220, and the at least one first microstructural portion 120 faces the at least one second microstructural portion 220. In the present embodiment, the number of first and second microstructural portions 120 and 220 are both three. The first microstructural portions 120 are spaced from each other, and the second microstructural portions 220 are spaced from each other.

Both the first microstructural portion 120 and the second microstructural portion 220 comprise a plurality of microstructures 101. The first microstructural portion 120 and the second microstructural portion 220 separate incident light into sub-beams. The period, groove depth, and duty cycle of the first grating structure 12 and of the second grating structure 22 can be set according to the demand. For example, the period of the first grating structure 12 is 0.4 um. A microstructure morphology can be rectangular as an example, and can also be trapezoidal or other shape. The groove depth h=150 nm, and duty cycle is 0.3. The period, groove depth, and duty cycle of the second grating structure 22 can be the same or different from those of the first grating structure 12.

In this embodiment, the diffractive optical structure 100 further includes at least one first resistor 40 and at least one second resistor 50. The at least one first resistor 40 is formed on a surface of the first diffractive element 10 deviating from the first grating structure 12, and the at least one second resistor 50 is formed on a surface of the second diffractive element 20 deviating from the second grating structure 22. The first resistor 40 corresponds to the position of the at least one first microstructural portion 120, and the second resistor 50 corresponds to the position of the at least one second microstructural portion 220.

In the present embodiment, the first resistor 40 and the second resistor 50 are both plural, the first resistors 40 are spaced from each other, and the second resistors 50 are spaced from each other. Each first resistor 40 and a facing second resistor 50 together form a resistance pair, and the resistance pair is used to detect a capacitance value between the first grating structure 12 and the second grating structure 22. When the first grating structure 12 and/or the second grating structure 22 are deformed due to external force or when there is a foreign body entering between the first grating structure 12 and the second grating structure 22, the capacitance value between the first grating structure 12 and the second grating structure 22 will change, which can be detected by the first resistor 40 and the second resistor 50.

The first resistors 40 are formed on the surface of the first diffractive element 10 facing away from the first grating structure 12 in a form of a coated film, the second resistors 50 are formed on the surface of the second diffractive element 20 facing away from the second grating structure 22 in the form of a plated film. The first resistor 40 and the second resistor 50 are made of transparent conductive material. The transparent conductive material is, for example, a tin oxide (ITO), a zinc oxide (IZO), an aluminum zinc oxide (AZO), a zinc oxide (GZO), a zinc oxide (ZnO), a tin oxide, or any combination thereof.

In the present embodiment, the diffractive optical structure 100 further includes two refractive index matching layers 60 disposed on the surfaces of the first resistor 40 and the second resistor 50. The refractive index matching layer 60 is made of a transparent dielectric material.

The refractive index matching layer 60 can be a single layer or a composite layer formed by materials with different refractive index. The materials of the refractive index matching layer 60 may include, but are not limited to, niobium oxide, titanium oxide, tantalum oxide, zirconia, silicon oxide, magnesium oxide, or any combination thereof. The refractive index matching layer 60 can be used as the refractive index buffer layer, which reduces the refractive difference between the diffractive element and the transparent base layer 70, while reducing the reflectivity. In this way, penetration and contrast are enhanced, and the quality of display improved.

In the present embodiment, the diffractive optical structure 100 further comprises two base layers 70 which are respectively formed on surfaces of the two refractive index matching layers 60 away from the first resistor 40 and the second resistor 50. The base layer 70 may be made of polyethylene (PE), polycarbonate (PC), polyethylene terephthalate (Polyethylene Terephthalate (PET), or fused silica.

In the present embodiment, the diffractive optical structure 100 further comprises two anti-reflective film layers 80 formed on the surfaces of the two base layers 70 away from the refractive index matching layer 60. The anti-reflective film layer 80 increases transmittance of light.

In the present embodiment, the diffractive optical structure 100 further includes a hollow cylindrical supporting frame 90, opposite ends of the supporting frame 90 support the first diffractive elements 10 and the second diffractive element 20 respectively. The optical adhesive 30, the first grating structure 12, and the second grating structure 22 are located in the supporting frame 90.

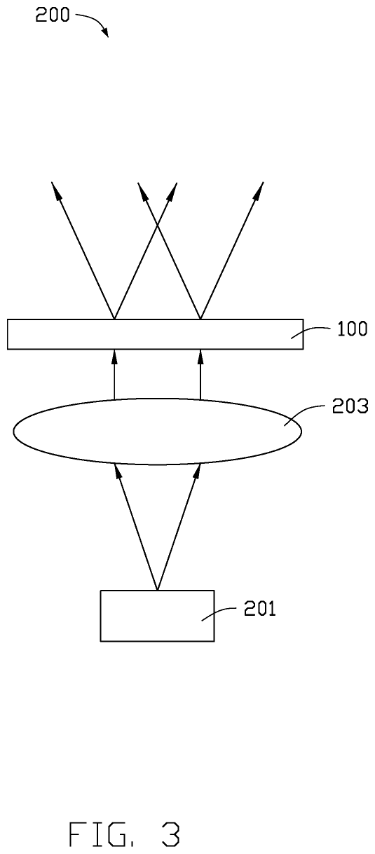

FIG. 3 illustrates a structured light projection device 200 according to a second embodiment. The structured light projection device 200 in FIG. 3 includes a light emitting assembly 201, an optical element 203, and the diffractive optical structure 100.

The light emitting assembly 201 may be an array of light sources or a backlight source. Specifically, the backlight emitting assembly 201 may be a liquid crystal display (LCD), light source. The array of the light emitting assembly 201 may be a VCSEL light source.

The optical element 203 is arranged on a light path of the light emitting assembly 201. The optical element 203 collimates light emitted from the light emitting assembly 201. In the embodiment, the optical element 2 is a convex lens. The structured light projection device 200 may include more than one collimation element 2.

The diffractive optical structure 100 is arranged on a light path of the optical element 203. The diffractive optical structure 100 expands light beams from the optical element 203 to form a fixed beam pattern and emit the fixed beam pattern outward. The diffractive optical structure 100 acts as a beam splitter, thus, for example, when a number of the beams transmitted to the diffractive optical structure 100 is one hundred, the first diffractive element 10 expands the light beam at a certain rate (such as 50), and can emit 5000 beams into the second diffractive element 20. The second diffractive element 20 can expand the light beam at a certain rate (such as 20), and eventually 100000 beams are projected into space. Ideally, there will be 100000 spots (in some cases, there will be some overlapping spots, resulting in a reduction in the number of spots).

The structured light projection device 200 is mainly used for 3D face recognition. The diffractive optical structure 100 has two diffractive elements which have function of dispersing a beam into N beams and shaping it to achieve a preset spot effect. After beam splicing and shaping by the diffractive optical structure 100, many light and dark spots will be formed to irradiate a face. According to the deformation degree and optical path of the light spot, a 3D face will be simulated. The brighter the light spot can be, the higher will be the resolution of 3D face recognition.

The structured light projection device 100 (200) provided by the disclosure does not increase an overall size of the structured light projection device 100 (200), and increases the number of reflections of light to increase the optical path, so as to realize optimization of the spots.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the portions within the principles of the present disclosure, up to and including the full extent established by the broad general meaning of the terms used in the claims. It will therefore be appreciated that the embodiments described above may be modified within the scope of the claims.

What is claimed is:

1. A diffractive optical structure, comprising:
a first diffractive element comprising a first grating structure; and
a second diffractive element comprising a second grating structure; the second grating structure faces and is spaced apart from the first grating structure,
wherein an optical adhesive is filled between the first grating structure and the second grating structure.

2. The diffractive optical structure of claim 1, wherein:
the first grating structure comprises at least one first microstructural portion;
the second grating structure comprises at least one second microstructural portion;
the at least one first microstructural portion faces the at least one second microstructural portion.

3. The diffractive optical structure of claim 2, wherein both the at least one first microstructural portion and the at least one second microstructural portion comprise a plurality of microstructures.

4. The diffractive optical structure of claim 3, further comprises at least one first resistor and at least one second resistor, wherein the at least one first resistor is formed on a surface of the first diffractive element deviating from the first grating structure, and the at least one of the second resistor is formed on a surface of a second diffractive element deviating from the second grating structure.

5. The diffractive optical structure of claim 4, wherein the at least one first resistor corresponds to a position of the at least one first microstructural portion, and the at least second resistor corresponds to a position of the at least one second microstructural portion.

6. The diffractive optical structure of claim 5, wherein the at least one first resistor and the at least one second resistor are made of transparent conductive material.

7. The diffractive optical structure of claim 6, further comprises two refractive index matching layers, wherein one refractive index matching layer is formed on a surface of the first diffractive element deviating from the first grating structure and covers the at least one first resistor, the other refractive index matching layer is formed on a surface of the second diffractive element deviating from the second grating structure and covers the at least one second resistor.

8. The diffractive optical structure of claim 7, further comprises two base layers, wherein one base layer is formed on a surface of the one refractive index matching layers away from the first resistor, the other base layer is formed on a surface of the other refractive index matching layers away from the second resistor.

9. The diffractive optical structure of claim 8, further comprises two anti-reflective film layers, wherein each of the two anti-reflective film layers is respectively formed on the surfaces of the two base layers away from the refractive index matching layer.

10. The diffractive optical structure of claim 9, wherein the two refractive index matching layers are made of a transparent dielectric material.

11. The diffractive optical structure of claim 10, further comprises a hollow cylindrical supporting frame, wherein opposite ends of the supporting frame support the first diffractive elements and the second diffractive element; the optical adhesive, the first grating structure, and the second grating structure are located in the supporting frame.

12. The diffractive optical structure of claim 1, wherein a refractive index of the optical adhesive is substantially equal to a refractive index of the first diffractive element.

13. A structured light projection device, comprising:
a light emitting assembly for emitting light;
an optical element for collimating light emitted from the light emitting assembly; and
a diffractive optical structure comprising:
a first diffractive element comprising a first grating structure;
a second diffractive element comprising a second grating structure; the second grating structure faces and is spaced apart from the first grating structure, wherein an optical adhesive is filled between the first grating structure and the second grating structure.

14. The structured light projection device of claim 13, wherein the first grating structure comprises at least one first microstructural portion, the second grating structure comprises at least one second microstructural portion, the at least one first microstructural portions corresponds the at least one second microstructural portion.

15. The structured light projection device of claim 14, wherein the diffractive optical structure further comprises at least one first resistor and at least one second resistor, the at least one first resistor is formed on a surface of a first diffractive element deviating from the first grating structure, and the at least one of the second resistor is formed on a surface of the second diffractive element deviating from the second grating structure.

16. The structured light projection device of claim 15, the diffractive optical structure further comprises two refractive index matching layers, one refractive index matching layer is formed on a surface of the first diffractive element deviating from the first grating structure and covers the at least one first resistor, the other refractive index matching layer is formed on a surface of the second diffractive element deviating from the second grating structure and covers the at least one second resistor.

17. The structured light projection device of claim 16, the diffractive optical structure further comprises two base layers, one base layer is formed on a surface of the one refractive index matching layers away from the first resistor, the other base layer is formed on a surface of the other refractive index matching layers away from the second resistor.

18. The structured light projection device of claim 17, the diffractive optical structure further comprises two anti-reflective film layers, each of the two anti-reflective film layers is respectively formed on the surfaces of the two base layers away from the refractive index matching layer.

19. The structured light projection device of claim 18, wherein the diffractive optical structure further comprises a hollow cylindrical supporting frame, opposite ends of the supporting frame support the first diffractive elements and the second diffractive element; the optical adhesive, the first grating structure, and the second grating structure are located in the supporting frame.
